(19) United States
(12) Patent Application Publication
(10) Pub. No.: US 2018/0376181 A1
(43) Pub. Date: Dec. 27, 2018

(54) NETWORKED VIDEO COMMUNICATION APPLICABLE TO GIGABIT ETHERNET

(71) Applicant: eSATURNUS NV, Leuven (BE)

(72) Inventors: Thomas KONINCKX, Blanden (BE); Robert KONINCKX, Leuven (BE)

(73) Assignee: eSATURNUS NV, Leuven (BE)

(21) Appl. No.: 15/759,567

(22) PCT Filed: Sep. 28, 2016
(86) PCT No.: PCT/EP2016/073159

§ 371 Date: Mar. 13, 2018

(30) Foreign Application Priority Data
Sep. 28, 2015 (GB) 1517136.6

(51) Int. Cl. H04N 21/242; H04N 7/015; H04N 7/12; H04N 13/167; H04N 13/194; H04N 21/61; H04N 21/81; H04N 21/845

(52) U.S. Cl. CPC H04N 21/242; H04N 7/015; H04N 7/12; H04N 13/167; H04L 49/352; H04N 21/6125; H04N 21/816; H04N 21/845; H04N 13/194

(57) ABSTRACT

A video data communication system for transmitting ultra-high definition video or three dimensional video stream over a packet switched network, including: an input receiving or obtaining plural high definition video streams representing a part of the ultra-high definition video stream or three dimensional video stream; a packet switched network transmitting at least part of the plural high definition video streams in parallel from a transmitter to a receiver; a receiver receiving the plural high definition video streams after the transmission over a packet switched network; a videogenlocker for generating a clock for the received high definition video streams and for synchronizing the received high definition video streams; and a combiner combining the synchronized received high definition video streams into a received ultra-high definition video stream or three dimensional video stream.

### FIELD OF THE INVENTION

The invention relates to the field of data and audio/video communication. More specifically it relates to methods and systems for low or ultra low latency video communication which can send UHD (ultra high definition) resolutions or 3D (three dimensional) video streams over a gigabit Ethernet.

### BACKGROUND OF THE INVENTION

Video data can be considered a three dimensional array of color or luminance data, depending if one refers to color or grayscale video. Two dimensions—horizontal and vertical—of this three dimensional array represent spatial data or so called pixels of a video image, whereas the third dimension represents the time domain of consecutive images. Hereafter each video image will be called a frame. A frame of pixel data generated by an imaging sensor is typically transferred to a processing or visualisation unit by serialising the data, and sending it via one or a limited set of communication lines. This said, the two dimensional spatial data of a single frame are transferred via a single communication line as a consecutive series of data in time. This communication line can carry analog data or digital codewords representing the original pixel data. By using multiple communication lines, data can be transferred more in parallel (e.g. some systems transfer red, green, blue and synchronization data in parallel). The above description typically explains how a camera system transports via a single cable its consecutive frame data to a display. A digital display will collect all consecutive data of a single frame in a buffer, and once the frame is completed it will present it to the display matrix for visualisation. In the remainder of this text, this will be referred to as a ‘direct video link’.

Video or image compression refers to bandwidth reduction either in the spatial domain (image compression) or in the spatial and temporal domain simultaneously (video compression). The principal goal of compression is to reduce the amount of data (bandwidth). The latter can either be done without losing any information (lossless compression). This said the original frame data can be reconstructed identically based on the compressed frame data, and is a bit-by-bit perfect match to the original. Alternatively compression can be done such that a human observer is unable to perceive the differences between the original and the compressed frame data (visual lossless compression). This said the original frame cannot be reconstructed identically, but a human observer typically will not see the differences between the original and reconstructed frame. Lastly compression can be ‘lossy’ and lower the amount of visual information in order to receive a strongly improved compression efficiency. Video compression exploits the fact that pixel data is typically strongly temporal and spatial redundant. Compression can be achieved by storing the differences between a pixel and one or more references spatially (intra-frame: e.g. used in the JPEG compression scheme) and by storing the differences between consecutive frames in the time domain (inter-frame: e.g. used in the MPEG compression scheme). Additionally, given that the human eye is not very sensitive to subtle variations in intensity and/or color, further compression can be obtained by reducing the amount of different variations which are retained after compression. Combinations of these techniques form the basics behind modern nowadays compression schemes like e.g. used in the MPEG1-MPEG2 and MPEG4 families and related.

A communication protocol is an agreement between computing or telecommunication systems for exchange of information. Communication protocols used on the internet/intranet are designed to function in a complex and uncontrolled setting. The design hereto typically uses a layering scheme as a basis, which decouples a larger and more complex protocol in distinct, easier to manage sub-protocols. The Internet protocol suite consists of the following layers: application-, transport-, internet- and network interface-functions. The Internet hereby offers universal interconnection, which means that any pair of computers connected to the internet is allowed to communicate. All the interconnected physical networks appear to the user as a single large network. This interconnection scheme is hence called the internet.

Communication protocols may include signaling, authentication, encryption and error detection and correction capabilities.

Video communication can be obtained through an electrical or optical ‘direct cable’ carrying raw video data, minimally or not compressed and typically using no higher level communication protocols. The classic cable based system typically yields fast low latency communication, but consumes high bandwidths and normally cannot be tunnelled through a complex communication network like the internet or an intranet. Additionally, traditional video cabling typically imposes limited maximum cable lengths, or it has to be extended with expensive and/or signal-specific technology such as UTP extenders, fiber-optic extenders, and satellite connections. Then, again, these technologies incur high costs for relatively limited flexibility to put multiple channels on the same “wire” and/or receive the same channel on multiple receivers. Internet capable video communication systems (e.g. used for telepresence) typically offer strong compression and work seamlessly over the internet/intranet, but always introduce a delay of one or more frames. In other words complex communication protocols and compression imply delay.

Despite the advanced stage of current systems for video communication there remains a need for a system combining low latency, strongly compressed internet/intranet capable video communication and possibly offering high visual quality. There is a lack of method or apparatus that could use the internet/intranet—or a communication channel of similar complexity—to send and receive video data with only a delay which is less than half of the time between two consecutive frames in the video feed presented to the sending unit. In other words, the surplus delay when compared to a ‘direct video link’ (cfr. sup.) of any prior system typically seems at least half of the inter frame time interval.

Genlock is a common technique in (mainly analog) video to synchronize the video output of different sources to a common generator signal, the latter can be also another video signal.

### SUMMARY OF THE INVENTION

It is an object of the present invention to provide good systems and methods for latency video communication which can transport Ultra High Definition video or Stereo Video Feeds over a packetized network, like Ethernet based IP networks (Video over IP).

It is an advantage of embodiments according to the present invention that the video communication can be low or ultra low latency video communication.

It is an advantage of embodiments according to the present invention that methods and systems are provided for a genlock algorithm which can be carried over a discrete and packetized network like the Ethernet.

It is an advantage of embodiments according to the present invention that glitches in the video display due to the beating of video clocks are omitted.

It is an advantage of embodiments according to the present invention that buffering and resampling, causing an increase of delay in a video communication system can be omitted.

It is an advantage of embodiments according to the present invention that different video sources with an unrelated video clock can be synchronized against a common generator video clock, with only the Ethernet in between the different video sources.

It is an advantage of embodiments according to the present invention that UHD video sources over Ethernet can be processed using the same tools, algorithms, codecs and systems for handling a number of independent HD video sources, e.g. four independent video sources.

It is an advantage of embodiments according to the present invention that 3D or stereo video sources over Ethernet can be processed using the same tools, algorithms, codecs and systems for handling two independent HD video sources.

It is an advantage of embodiments according to the present invention that UHD video sources can be transported at for example 3 to 30 times lower bandwidth consumption when compared to the original raw data feeds of over 12 Gigabit per second, effectively enabling high quality UHD over a Gigabit (1000 Base T) network instead of typically a 10 Gigabit (10000 Base T) network.

It is an advantage of embodiments according to the present invention that UHD video sources over Ethernet can be transported with a delay between the video input at the sending unit and the video output at the receiving unit which is less than one frame period of the video clock (inter frame time interval).

The present invention relates to a video data communication system for transmitting ultra-high definition video or three dimensional video stream over a packet switched network, the video data communication system comprising

an input means for receiving or obtaining a plurality of high definition video streams each of the streams representing a part of said ultra-high definition video stream or three dimensional video stream,
a packet switched network for transmitting at least part of the plurality of high definition video streams in parallel from a transmitter to a receiver,
a receiving means for receiving said plurality of high definition video streams after said transmission over the packet switched network,
a videogenlocker for generating a clock for said received high definition video streams and for synchronizing said received high definition video streams, and
a combining means for combining said synchronized received high definition video streams into a received ultra-high definition video stream or three dimensional video stream.

Said plurality of high definition streams each may represent high definition images which represent a segment of ultra-high definition images of the ultra-high definition video stream. The plurality of high definition streams each may represent high definition images which represent one of the two stereoscopic images of the three dimensional video stream.

The input means may comprise a means for receiving the ultra-high definition video stream or three dimensional video stream and a splitter means for splitting the ultra-high definition video stream or the three dimensional video stream into a plurality of high definition video streams which can be transmitted independently of each other.

The input means may be adapted for receiving four high definition video streams together constituting an ultra-high definition.

A transmission rate for ultra-high definition video streams may be lower than 1 Gigabit per second.

The video data communication system furthermore may comprise, for each high definition video stream, a transmission unit comprising an image acquiring circuitry or an image reconstruction circuitry for acquiring or reconstructing an image frame or image field, a video processing unit for processing at least part of the high definition video data and a communication unit for sending or receiving at least part of the data, wherein at least two of the image acquiring circuitry or image reconstruction circuitry, the video processing unit and the communication unit are arranged for simultaneously handling different parts of a same image frame, the parts not being a complete image field, or different parts of a same image field of the high definition video data.

The latency for the ultra-high definition video stream may be less than one inter-frame period in the video stream.

The present invention also relates to a method for transmitting ultra-high definition video or three dimensional video stream over a packet switched network, the method comprising

receiving or obtaining a plurality of high definition video streams each of the streams representing a part of said ultra-high definition video stream or three dimensional video stream,
transmitting at least part of the plurality of high definition video streams in parallel over a network,
receiving said plurality of high definition video streams after said transmission over a packet switched network,
generating a clock for said received high definition video streams and synchronizing said received high definition video streams, and
combining said synchronized received high definition video streams into a received ultra-high definition video stream or three dimensional video stream.

Said plurality of high definition streams each may represent high definition images which represent a segment of ultra-high definition images of the ultra-high definition video stream. The method may comprise adding information to the header of said plurality of high-definition video streams indicative of a spatial configuration of the video stream with respect to the other video streams.

Said obtaining a plurality of high definition may comprise receiving the ultra-high definition video stream and splitting the ultra-high definition video stream into a plurality of high definition video streams.

The method may comprise

acquiring or reconstructing an image frame or image field
processing at least part of the video data, and
sending or receiving at least part of the data,
wherein at least two of said acquiring or reconstructing, processing and sending or receiving may be performed simultaneously by simultaneously handling different parts of the same image frame, the parts not being a complete image field, or different parts of the same image field of said high definition video streams.

The present invention also relates to a set of video streams, the video streams being high definition video streams all being representative of a segment of an ultra-high definition video stream, the high definition video streams together constituting the ultra-high definition video stream, wherein said video streams comprise a header, said header comprising information regarding the spatial configuration of the high definition video streams with respect to an ultra-high definition video stream.

The present invention also relates to the use of a video data communication system as described above in a stereoscopic or three dimensional video data.

The present invention furthermore relates to the use of a video data communication system as described above, for combining multiple high-definition video data inputs and for providing multiple high-definition video data outputs or providing a merged data output.

The present invention also relates to the use of a video data communication system as described above, for obtaining visual delay free transport of ultra-high definition video data. Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 illustrates a schematic overview of components of a system according to an embodiment of the present invention.

FIG. 2 illustrates an example of transmission of 3D camera images over a packet switched network according to an embodiment of the present invention.

FIG. 3 illustrates an example of transmission of UHD image feeds over a packet switched network according to an embodiment of the present invention.

The drawings are only schematic and are non-limiting. In the drawings, the size of some of the elements may be exaggerated and not drawn on scale for illustrative purposes.

Any reference signs in the claims shall not be construed as limiting the scope.

### DETAILED DESCRIPTION OF EMBODIMENTS OF THE PRESENT INVENTION

Although the present invention will hereinafter be described with respect to particular embodiments and with reference to certain drawings, the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms ‘first’, ‘second’ and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, above, front and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term ‘including’, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression ‘a device including means A and B’ should not be limited to devices consisting only of components A and B. It means that with respect to the present invention, the only relevant components of the device are A and B.

Reference throughout this specification to ‘one embodiment’ or ‘an embodiment’ means that a particular feature, structure or characteristic described in connection with the embodiment is included in at least one embodiment of the present invention. Thus, the appearance of the phrases ‘in one embodiment’ or ‘in an embodiment’ in various places throughout this specification do not necessarily all refer to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the description of illustrative embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In a first aspect, the present invention relates to a video data communication system for transmitting an ultra-high definition video stream or a three dimensional video stream. Where in embodiments of the present invention reference is made to an ultra-high definition video stream, reference is made to a video representing a stream of ultra-high definition images. Ultra-high definition images thereby are defined as images having a resolution of at least 4 times, e.g. 4 times or 8 times or 16 times the resolution of a high definition image. High definition images typically comprise 1080 lines (e.g. not more than 1080 lines)

According to embodiments of the present invention, the ultra-high definition video or three dimensional video, e.g. stereoscopic video, are transmitted as independent synchronised data over the internet. The independent synchronised data is treated as normal video, such as for example as high definition video streams.

According to embodiments of the present invention, the video data communication system comprising an input means for receiving or obtaining a plurality of high definition video streams each of the streams representing a part of said ultra-high definition video stream or three dimensional video stream. The input means may receive a plurality, e.g. four, high definition video streams directly from an external source. Alternatively, the input means may be adapted for receiving an ultra-high definition video stream or a three dimensional video stream and for splitting it into different independent high-definition streams.

The system furthermore comprises a packet switched network for transmitting at least part of the plurality of high definition video streams in parallel, from a transmitter to a receiver. Examples of such a packet switched network, also referred to as internet-based transmission lines may be the Ethernet or an intranet.

The system also comprises a receiving means for receiving the independent plurality of high definition video streams after said transmission over the internet-based transmission line. The receiving means may be different HD video stream receivers. The system furthermore comprises a videogenlocker for generating a clock for said received high definition video streams and for synchronizing said received high definition video streams.

The system furthermore comprises a combining means for combining said synchronized received high definition video streams into a received ultra-high definition video stream or three dimensional video stream. Such a system may for example be a screen.

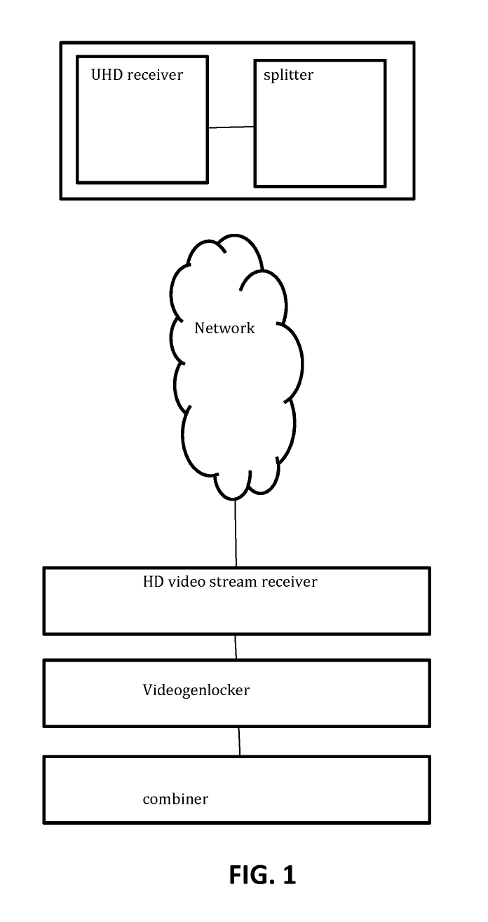

By way of illustration, embodiments of the present invention not being limited thereto, a schematic representation of a system according to embodiments of the present invention is shown in FIG. 1.

In advantageous embodiments, the present invention not being limited thereto, the system advantageously furthermore comprises, for each high definition video stream, a transmission unit comprising an image acquiring circuitry or an image reconstruction circuitry for acquiring or reconstructing an image frame or image field, a video processing unit for processing at least part of the high definition video data and a communication unit for sending or receiving at least part of the data. At least two of the image acquiring circuitry or image reconstruction circuitry, the video processing unit and the communication unit are arranged for simultaneously handling different parts of a same image frame, the parts not being a complete image field, or different parts of a same image field of the high definition video data. The parallel processing can for example be obtained using a system as described in European patent application EP2777257.

By way of illustration two further examples are described.

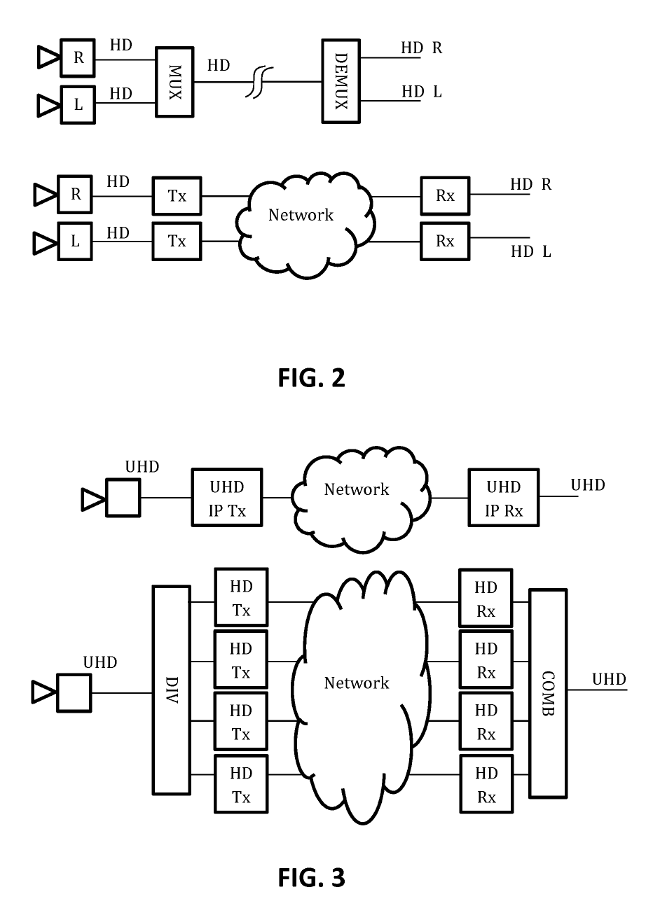

FIG. 2 shows in the top row a stereo or 3D camera pair in HD, being multiplexed (MUX) into a standard HD video comprising the left and right image. This lowers the resolution by a factor 2, and depending on the muxing can seriously complicate the signal processing.

In the bottom row the left and right image feeds are transported independently over the network, using an embodiment of present invention keeping the resolution intact and facilitating any kind of data processing.

FIG. 3 shows in the top row an UHD video over IP transmitter and receiver pair, sending the data of the network. The UHD video over IP transmitter in this case has to be designed explicitly for this matter, w.r.t. codec, protocols, etc. Currently no implementation does exist combining Ultra Low latency (less than one inter-frame period) with advanced data reduction (less than one Gigabit).

In the bottom row the UHD image feeds are transported independently over the network, using an embodiment of present invention possibly combining both Ultra Low Latency and advanced data reduction. Please note that the division (DIV) of an UHD video in four independent HD videos is supported in the UHD standard, similarly for the combination of four HD videos into a UHD video (COMB).

In one aspect, a method for transmitting ultra-high definition video or three dimensional video stream over a packet switched network is described. The method comprises receiving or obtaining a plurality of high definition video streams each of the streams representing a part of said ultra-high definition video stream or three dimensional video stream. The method also comprises transmitting at least part of the plurality of high definition video streams in parallel over a network and receiving said plurality of high definition video streams after said transmission over a packet switched network. The method further comprises generating a clock for said received high definition video streams and synchronizing said received high definition video streams, and combining said synchronized received high definition video streams into a received ultra-high definition video stream or three dimensional video stream. The plurality of high definition streams each may represent high definition images which represent a segment of ultra-high definition images of the ultra-high definition video stream. The method may comprise adding information to the header of said plurality of high-definition video streams indicative of a spatial configuration of the video stream with respect to the other video streams.

Obtaining a plurality of high definition may comprise receiving the ultra-high definition video stream and splitting the ultra-high definition video stream into a plurality of high definition video streams.

The method may comprise acquiring or reconstructing an image frame or image field, processing at least part of the video data, and sending or receiving at least part of the data, wherein at least two of said acquiring or reconstructing, processing and sending or receiving may be performed simultaneously by simultaneously handling different parts of the same image frame, the parts not being a complete image field, or different parts of the same image field of said high definition video streams.

Further standard and optional method steps of embodiments of the present invention may correspond with the functionality described for different elements and features of the video communication system described in the first aspect.

In another aspect, the present invention relates to a set of video streams, the video streams being high definition video streams all being representative of a segment of an ultra-high definition video stream, the high definition video streams together constituting the ultra-high definition video stream, wherein said video streams comprise a header, said header comprising information regarding the spatial configuration of the high definition video streams with respect to an ultra-high definition video stream.

In yet another aspect, the present invention also relates to the use of a video data communication system as described in the first aspect in a stereoscopic or three dimensional video data. The present invention furthermore relates to the use of a video data communication system as described above, for combining multiple high-definition video data inputs and for providing multiple high-definition video data outputs or providing a merged data output. The present invention also relates to the use of a video data communication system as described above, for obtaining visual delay free transport of ultra-high definition video data.

The above described system embodiments for transmitting ultra-high definition video or three dimensional video stream over a packet switched network may correspond with an implementation of the method embodiments for transmitting ultra-high definition video or three dimensional video stream over a packet switched network as a computer implemented invention in a processor. One configuration of such a processor may for example include at least one programmable computing component coupled to a memory subsystem that includes at least one form of memory, e.g., RAM, ROM, and so forth. It is to be noted that the computing component or computing components may be a general purpose, or a special purpose computing component, and may be for inclusion in a device, e.g., a chip that has other components that perform other functions. Thus, one or more aspects of the present invention can be implemented in digital electronic circuitry, or in computer hardware, firmware, software, or in combinations of them. For example, each of the method steps may be a computer implemented step. Thus, while a processor as such is prior art, a system that includes the instructions to implement aspects of the methods for transmitting ultra-high definition video or three dimensional video stream over a packet switched network is not prior art.

The present invention thus also includes a computer program product which provides the functionality of any of the methods according to the present invention when executed on a computing device.

In another aspect, the present invention relates to a data carrier for carrying a computer program product for transmitting ultra-high definition video or three dimensional video stream over a packet switched network. Such a data carrier may comprise a computer program product tangibly embodied thereon and may carry machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non-volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

1. A video data communication system for transmitting ultra-high definition video or three dimensional video stream over a packet switched network, the video data communication system comprising
an input means for receiving or obtaining a plurality of high definition video streams each of the streams representing a part of said ultra-high definition video stream or three dimensional video stream,
an a packet switched network for transmitting at least part of the plurality of high definition video streams in parallel from a transmitter to a receiver,
a receiving means for receiving said plurality of high definition video streams after said transmission over the packet switched network,
a videogenlocker for generating a clock for said received high definition video streams and for synchronizing said received high definition video streams, and
a combining means for combining said synchronized received high definition video streams into a received ultra-high definition video stream or three dimensional video stream.

2. A video data communication system according to claim 1, wherein said plurality of high definition streams each represent high definition images which represent a segment of ultra-high definition images of the ultra-high definition video stream.

3. A video data communication system according to claim 1, wherein said plurality of high definition streams each represent high definition images which represent one of the two stereoscopic images of the three dimensional video stream.

4. A video data communication system according to claim 1, wherein the input means comprises a means for receiving the ultra-high definition video stream or three dimensional video stream and a splitter means for splitting the ultra-high definition video stream or the three dimensional video stream into a plurality of high definition video streams which can be transmitted independently of each other.

5. A video data communication system according to claim 1, wherein the input means is adapted for receiving four high definition video streams together constituting an ultra-high definition.

6. A video data communication system according to claim 1, wherein a transmission rate for ultra-high definition video streams is lower than 1 Gigabit per second.

7. A video data communication system according to claim 1, wherein the video data communication system furthermore comprises, for each high definition video stream, a transmission unit comprising an image acquiring circuitry or an image reconstruction circuitry for acquiring or reconstructing an image frame or image field, a video processing unit for processing at least part of the high definition video data and a communication unit for sending or receiving at least part of the data, wherein at least two of the image acquiring circuitry or image reconstruction circuitry, the video processing unit and the communication unit are arranged for simultaneously handling different parts of a same image frame, the parts not being a complete image field, or the parts being different parts of a same image field of the high definition video data.

8. A video data communication system according to claim 7, wherein the latency for the ultra-high definition video stream is less than one inter-frame period in the video stream.

9. A method for transmitting ultra-high definition video or three dimensional video stream over a packet switched network, the method comprising
receiving or obtaining a plurality of high definition video streams each of the streams representing a part of said ultra-high definition video stream or three dimensional video stream,
transmitting at least part of the plurality of high definition video streams in parallel over a network,
receiving said plurality of high definition video streams after said transmission over the packet switched network,
generating a clock for said received high definition video streams and synchronizing said received high definition video streams, and
combining said synchronized received high definition video streams into a received ultra-high definition video stream or three dimensional video stream.

10. A method according to claim 9, wherein said plurality of high definition streams each represent high definition images which represent a segment of ultra-high definition images of the ultra-high definition video stream.

11. A method according to claim 9, the method comprising adding information to the header of said plurality of high-definition video streams indicative of a spatial configuration of the video stream with respect to the other video streams.

12. A method according to claim 9, wherein said obtaining a plurality of high definition comprises receiving the ultra-high definition video stream and splitting the ultra-high definition video stream into a plurality of high definition video streams.

13. A method according to claim 9, wherein the method comprises
acquiring or reconstructing an image frame or image field
processing at least part of the video data, and
sending or receiving at least part of the data,
wherein at least two of said acquiring or reconstructing, processing and sending or receiving are performed simultaneously by simultaneously handling different parts of the same image frame, the parts not being a complete image field, or different parts of the same image field of said high definition video streams.

14. A set of video streams, the video streams being high definition video streams all being representative of a segment of an ultra-high definition video stream, the high definition video streams together constituting the ultra-high definition video stream, wherein said video streams comprise a header, said header comprising information regarding the spatial configuration of the high definition video streams with respect to an ultra-high definition video stream.

15. Use of a video data communication system according to claim 1, in a stereoscopic or three dimensional video data.

16. Use of a video data communication system according to claim 1, for combining multiple high-definition video data inputs and for providing multiple high-definition video data outputs or providing a merged data output.

17. Use of a video data communication system according to claim 1, for obtaining visual delay free transport of ultra-high definition video data.
